(19) United States
(12) Patent Application Publication
(10) Pub. No.: US 2025/0341293 A1
(43) Pub. Date: Nov. 6, 2025

(54) GLARE REDUCTION FOR A LIGHTING DEVICE

(71) Applicant: SIGNIFY HOLDING B.V., EINDHOVEN (NL)

(72) Inventors: ALDEGONDA LUCIA WEIJERS, EINDHOVEN (NL); JOHANNES PETRUS MARIA ANSEMS, HULSEL (NL); ERIC CORNELIS EGBERTUS VAN GRUNSVEN, SOMEREN (NL); MICHAL JAN HORACZEK, BEST (NL); MARTINUS PETRUS JOSEPH PEETERS, WEERT (NL)

(21) Appl. No.: 18/862,245

(22) PCT Filed: Apr. 25, 2023
(86) PCT No.: PCT/EP2023/060737

§ 371 Date: Nov. 1, 2024

(30) Foreign Application Priority Data
May 3, 2022 (EP) 22171257.3

(51) Int. Cl. F21K 9/64; F21K 9/237

(52) U.S. Cl. CPC F21K 9/64; F21K 9/237

(57) ABSTRACT

A lighting device (10) is provided. The lighting device (10) comprises: a light emitting element (11), and a translucent envelope (20) enclosing the light emitting element (11) and having a surface area at least three times bigger than the light emitting area of the light emitting element (11), wherein the envelope (20) is coated with a layer (22) of phosphor with a thickness of 0.05-1.0 mm and the layer (22) of phosphor is configured to block less than 30% of the visible light emitted by the light emitting element (11).

### FIELD OF THE INVENTION

The present invention generally relates glare reduction. In particular, it relates to a lighting device comprising glare reducing features.

### BACKGROUND OF THE INVENTION

Home and professional environments contain a large number of lighting devices for creation of functional, ambient, atmosphere, accent or task lighting. It is well known that people need high lux levels to read, do tasks or even for their wellbeing. When lighting devices are used as such a high flux source, e.g. providing 800 lumen, these lighting devices can become very glary and be unpleasant to use: the brightness of the light emitting element is too high for direct viewing. Some lighting devices modify the light emitting element to reduce the glare, e.g. by increasing its effective area. However, such light emitting elements are not always appropriate, either for practical or aesthetic reasons. Accordingly, it would be desirable to reduce glare in another way.

### SUMMARY OF THE INVENTION

It is therefore an object of the present invention to provide a lighting device with reduced glare. The inventors have realized that it is possible to increase the effective area of the lighting device, and thereby reduce glare, by coating an envelope of the lighting device with a layer of phosphor without affecting the light emitting element.

According to a first aspect of the present invention, the object is achieved by a lighting device having the features in the independent claim. Preferred embodiments are defined in the dependent claims.

Hence, according to a first aspect of the present invention, there is provided a lighting device comprising: a light emitting element; a translucent envelope enclosing the light emitting element and having a surface area at least three times bigger than the light emitting area of the light emitting element; wherein the envelope is coated with a layer of phosphor with a thickness of 0.05-1.0 mm and the layer of phosphor is configured to block less than or equal to 30 or 20% of the visible light emitted by the light emitting element.

The layer of phosphor will absorb some of the light emitted by the light emitting element and re-emit the light (through electron relaxation photon emissions). By coating the envelope with phosphor, the envelope will emit light along the surface area where it is coated, thereby further increasing the light emitted across the larger area of the envelope.

The envelope has a surface area that is at least three times bigger than the light emitting area of the light emitting element, such as five times bigger or ten or twenty times bigger.

Thus, the present invention is based on the idea of providing a layer of phosphor that, by absorbing light emitted by the light emitting element and re-emitting it, may emit light in a larger area, i.e. the entire surface area of the envelope or at least 50-80% of it. The surface area of the envelope may be 10-20 times or even more than 50 times larger than the light emitting element, depending on the type of light emitting element and envelope. Thereby, the effective area of the light emitting element is increased and glare is reduced.

The light emitting element may be used to deliver functional lighting. The light from the layer of phosphor may impart a white or colorful glow to the lighting device. This way, it may deliver high flux with low glare to enable functional light that meets standards for eye comfort, or white light with an aesthetically pleasing color glow effect.

The light emitting element may be an LED filament, a lightguide LED, or a direct emitting LED.

The lighting device may e.g. be a light bulb or a luminaire.

The envelope may be any shape such as a bulb and may be flat or curved (in one or two directions).

The present invention may thereby be advantageous in that the glare is reduced while the light emitting element remains unaltered.

According to an embodiment of the present invention, the phosphor is organic phosphor (as opposed to normal LED phosphors).

The main components of the layer of phosphor are thereby organic and phosphor, i.e. carbon, hydrogen, nitrogen and e.g. fluorine or any other halogen. A well-known group of materials are the so-called perylene diamides group of molecules.

According to an embodiment of the present invention, the thickness of the layer of phosphor differs in different portions of the envelope.

A different thickness may be used to selectively increase light being re-emitted in specific portions of the envelope, e.g. in portions where light from the first and/or LED does not reach.

According to an embodiment of the present invention, the layer of phosphor comprises scattering particles different from phosphor.

The scattering particles may change a color or hue of the light being emitted by the lighting device.

According to an embodiment of the present invention, the envelope is only coated with said layer of phosphor.

Some lighting devices are coated with e.g. amber for an aesthetic effect, however such a coating absorbs 5-20% of the light and does not re-emit the absorbed light, thereby reducing the optical efficiency of the lighting device. Such a coating is especially common when the light emitting element is a filament. The layer of phosphor may replace the need for other layers such as an amber layer, thereby increasing efficiency as the layer of phosphor re-emits the absorbed light, such as more than 75% or more than 85% of the absorbed light (whereby losses may be partially attributed to Stokes shift).

According to an embodiment of the present invention, the light emitting element filament comprises a separately controllable ultraviolet (UV) light source and wherein the layer of phosphor is configured to absorb UV light and re-emit it as visible light.

The UV light may e.g. be within the UVA and/or UVB light spectrum. The re-emitted light may be entirely within the visible light spectrum.

This may enable more specific control of the lighting device 10. For example, only non-visible UV light may be emitted from the light emitting element and the layer of phosphor (re-)emits visible light, causing the envelope to light up without seeing the light emitting element emit light.

According to an embodiment of the present invention, the light emitting element is an LED filament.

An LED filament may be perceived as especially glary. Further, this results in a combination of the benefits of filament technology with that of phosphorescence, leading to a new category of retrofit lighting devices.

According to an embodiment of the present invention, the layer of phosphor is patterned.

A pattern may thereby be reproduced by the light emitted by the lighting device. The layer of phosphor may comprise a pattern of dots of phosphor. The dots may be very small, such as less than 1 mm in diameter, and may be invisible to the naked eye.

According to an embodiment of the present invention, the layer of phosphor comprises grinded particles of a polymer incorporating the phosphor.

Such grinded particles may scatter light and may be simple to manufacture.

According to an embodiment of the present invention, the lighting device further comprises an LED arranged in connection with the envelope, such that the envelope acts as a light guide for the LED.

The light from the LED is coupled into the envelope, the envelope being made from a translucent material with relatively low light scattering properties, giving a white or colorful glow to the lighting device. This way, it may deliver high flux with low glare to enable functional light that meets standards for eye comfort, or white light with an aesthetically pleasing color glow effect.

The LED may be a set of direct emitting LEDs or mini-LEDs, or a one-sided emitting LED filament.

Further, by using two light emitting elements, each light emitting element may emit less lumen to achieve the same flux levels, further reducing glare.

According to an embodiment of the present invention, the light emitting element and the LED are separately controllable.

Thereby, a different lumen, color, and/or color temperature may be set for each of the light emitting element and the LED.

According to an embodiment of the present invention, the envelope is configured to, when acting as a light-guide for the LED, emit light such that at least 50% of the area of the envelope emits light with a luminance that differs less than a factor of five from an average luminance of the envelope.

Luminance is measured in candela per square meter and may be perceived as brightness. The area may e.g. be the area of the envelope or a projection of the light emitted by the lighting device. Any known method of measuring luminance may be used to ensure that it does not differ more than a factor of five between said portion(s) of the envelope and the average.

Thereby, the envelope emits light that is relatively evenly distributed along the area of the envelope, thereby further increasing the effective area of the emitted light.

According to an embodiment of the present invention, the LED is configured to emit light with a minimum luminance threshold when the light emitting element emits light above a predetermined threshold of luminance.

By the LED emitting light with a minimum luminance threshold when the light emitting element emits light above a predetermined threshold of luminance, the LED is enabled to reduce glare when light emitting element emits light with enough luminance to be perceived as glary.

Luminance is measured in candela per square meter and may be perceived as brightness. The area may e.g. be the area of the envelope or a projection of the light emitted by the lighting device. Luminance may be measured in any number of ways known in the art, as long as the luminance thresholds are calibrated against each other.

According to an embodiment of the present invention, the minimum luminance threshold is proportional to an amount of flux emitted by the light emitting element.

Thereby, the more amount of flux emitted by the light emitting element, the greater the glare reducing effect of the LED is enforced.

According to an embodiment of the present invention, the LED and the light emitting element have a same correlated color temperature.

By the light emitting element and the LED having the same correlated color temperature, an aesthetic perception of the lighting device may be enhanced.

According to an embodiment of the present invention, the envelope is made of PMMA, glass, or polycarbonate.

These materials have been shown to be sufficiently translucent and have relatively low scattering properties, which enables light outcoupling over the entire area of the envelope. A thickness and choice of material may be affected by the choice of LED, such that ideal light scattering properties are achieved.

According to an embodiment of the present invention, the LED emits colored light.

The colored light may e.g. be an RGB or non-white LED.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIG. 1 schematically shows a lighting device according to an exemplifying embodiment of the present invention, and

FIG. 2 schematically shows a lighting device according to an exemplifying embodiment of the present invention.

### DETAILED DESCRIPTION

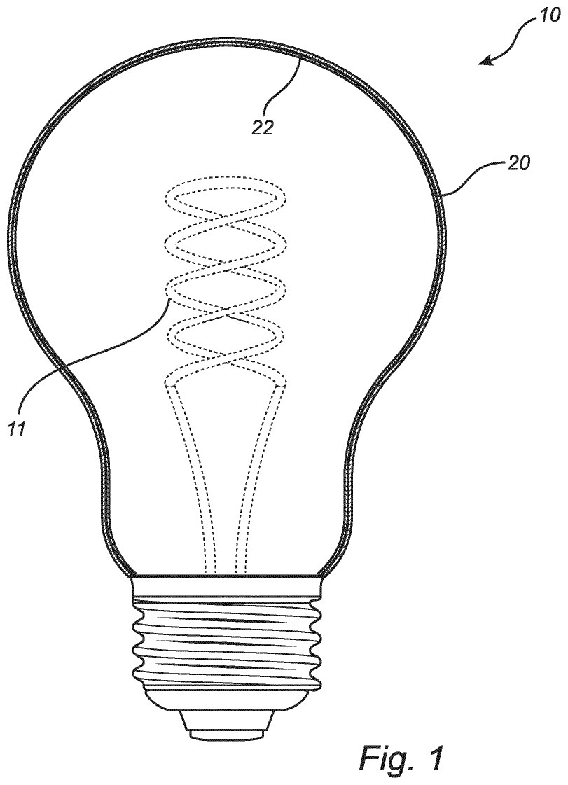

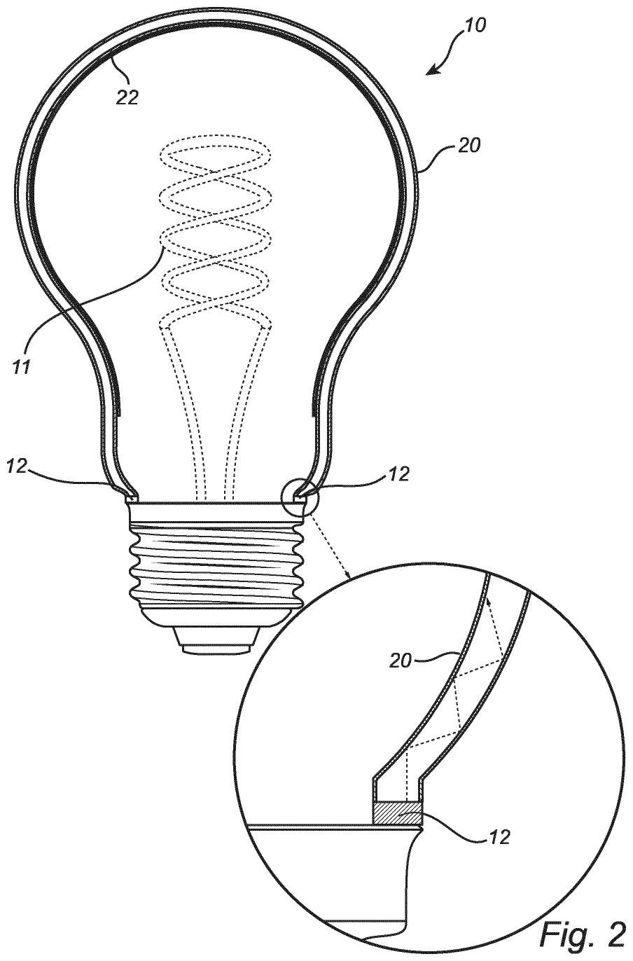

FIG. 1 schematically shows a lighting device 10. The lighting device 10 shown in FIGS. 1 and 2 is a light bulb, however other lighting devices are possible within the scope of the appended claims. For example, the lighting device 10 may be a light strip and may be a HUE® light source.

The lighting device 10 comprises a light emitting element 11. In the exemplifying embodiment of FIG. 1, the light emitting element 11 is a light emitting diode (LED) filament, however other light emitting elements are possible within the scope of the appended claims.

The lighting device 10 further comprises a translucent envelope 20 enclosing the light emitting element 11. The envelope 20 may hermetically seal a volume of gas or vacuum that surrounds the light emitting element 11. The envelope 20 being translucent may mean that most of the light emitted by the light emitting element 11 will be transmitted because even if light is reflected (because of Fresnel reflection) or scattered (by internal scattering particles), the light has a second (or third, or fourth . . . ) chance to get through the envelope 20 at a different location. The envelope 20 being translucent may mean that at least 70% of the light emitted by the light emitting element 11 will be transmitted through the envelope 20 at a first pass, or preferably at least 85% of the light.

The envelope 20 is coated with a layer 22 of phosphor.

The layer 22 of phosphor partly absorbs and partly re-emits light emitted by the light emitting element 11. This enables e.g. part of the light emitted by the light emitting element 11 to be absorbed by the layer 22 of phosphor and re-emitted across the entire layer 22 of phosphor. This increases the effective area of the light emitting element 11.

The layer 22 of phosphor may cover the entire area of the envelope 20, or at least 50% or at least 80% of the area of the envelope 20.

The layer 22 of phosphor may be made of the same phosphor as a coating on the light emitting element 11. The layer 22 of phosphor may further be made of a different composition of phosphor as the coating on the light emitting element 11, which may result in a difference in color emitted by the light emitting element 11 and the re-emitted light of the layer 22 of phosphor.

In general, it may be beneficial for aesthetic reasons or color homogeneity for the re-emitted light from the layer 22 of phosphor to have a white point as close as possible to the black body line of the light. The layer 22 of phosphor may be configured to have a white point relatively close to the black body line of the light. In order to manipulate the white point of the total device even closer to the black body line, a coating of the light emitting element 11 may be adapted to e.g. have less phosphor in order to compensate for the effect of the layer 22 of phosphor.

The layer 22 of phosphor may be configured to block (i.e. absorb without re-emission) less than or equal to 30% or 20% or less than 10% or 5% of the visible light emitted by the light emitting element 11. This means that the efficiency of the lighting device 10 is not sacrificed by more than 30% for the sake of glare reduction.

The layer 22 of phosphor has a thickness of 0.05-1.0 mm, such as 0.1 mm or 0.3 mm. The thickness of the layer 22 of phosphor may differ in different portions of the envelope 20. For example, the layer 22 of phosphor may be thicker in areas where light emitted from the light emitting element 11 does not reach as effectively as other areas. Further, the layer 22 of phosphor may be diluted or compact and may be deposited in any way known in the art.

In one embodiment, the layer 22 of phosphor is applied only to certain portions of the envelope 20 and may e.g. form a pattern. A pattern may thereby be reproduced by the light emitted by the lighting device 10. The layer 22 of phosphor may comprise a pattern of dots of phosphor. The dots may be very small, such as less than 1 mm in diameter, and may be invisible to the naked eye.

Preferably, two different types of blue light sources are used. The light emitting element may be a phosphor converting LED with a centroid wavelength of 450 nm and a yellow phosphor to generate white light. This light emitting element may be a LED filament. The LED that is arranged in connection with the envelope may be a blue emitting LED with a centroid wavelength of 430 nm. In case the envelope that is provided with a blue light emitting phosphor, the light emitted by the lighting device will have a nice white appearance in the far field. The light emitting element will emit more yellow white light having a low color temperature in the range of for instance 1800-2200 K that will be mixed with the bluish light from the envelope.

FIG. 2 shows the layer 22 of phosphor coating the inside of the envelope 20, however in other embodiments the layer 22 of phosphor may be coated on the outside of the envelope 20, i.e. not facing the light emitting element 11. It is preferred to have the layer 22 of phosphor coating the inside of the envelope 20.

The phosphor may be organic phosphor. This means that the layer 22 of phosphor is non-scattering, which may improve aesthetics and efficiency compared to e.g. non-organic phosphor. Organic phosphor does not rely on a (transition) metal ion for its light emission, but rather on photoluminescence. The main components are thereby organic and phosphor, i.e. carbon, hydrogen, nitrogen and e.g. fluorine or other halogens. These components may form an organometallic complex and/or be incorporated in a polymer such as PMMA or polyethylene terephthalate (PET).

The layer 22 of phosphor may further comprise scattering particles different from phosphor. If the layer 22 of phosphor is patterned, the scattering particles may have the same or a different pattern. The scattering particles may change a color or hue of the light being emitted by the lighting device 10. Alternatively, the structure of the layer 22 of phosphor or incorporating the phosphor may scatter light in a similar manner.

The layer 22 of phosphor may comprise grinded particles of a polymer such as PMMA or PET incorporating the phosphor. Such grinded particles may scatter light. Some lighting devices 10 are coated with e.g. amber for an aesthetic effect. This is especially common when the light emitting element 11 is a filament. The layer 22 of phosphor may replace the need for other layers such as an amber layer. Accordingly, the layer 22 of phosphor may be the only coating on the envelope 20 of the lighting device 10.

The light emitting element 11 may comprise a separately controllable ultraviolet (UV) light source. The layer 22 of phosphor may then be configured to absorb UV light and re-emit it as visible light. The UV light may e.g. be within the UVA and/or UVB light spectrum. The re-emitted light may be entirely within the visible light spectrum. This property of phosphor may be inherent to the phosphor.

This enables more specific control of the lighting device 10. For example, only non-visible UV light is emitted from the light emitting element 11 and the layer 22 of phosphor (re-)emits visible light, causing the envelope 20 to light up without seeing the light emitting element 11 emit light.

FIG. 2 schematically shows a lighting device 10 similar to the one in FIG. 1. The lighting device 10 in FIG. 2 differs from the one in FIG. 1 in that the lighting device 10 also comprises an LED 12.

The LED 12 is arranged in connection with the translucent envelope 20 such that the envelope 20 acts as a light guide for the LED 12. This arrangement is shown in an inset of FIG. 2. Accordingly, light emitted by the LED 12 is directed into the envelope 20, which acts as a light guide to guide the light within the envelope 20.

It is noted that the sharp edge of the envelope 20 shown in the inset of FIG. 2 is merely schematic, and this may be smooth in another embodiment.

The LED 12 may e.g. be a set of LEDs or mini-LEDs, or a one-sided emitting LED filament.

Additionally, the LED 12 may be a two-sided emitting LED filament, e.g. when a flexible printed circuit (FPC) is used as carrier for the filament, since the FPC may be made translucent.

The envelope 20 is made of a translucent material with relatively low scattering properties, such that light from the LED 12 is outcoupled from the envelope 20 along the area of the envelope 20. Preferably, the material properties of the envelope 20 is selected such that light from the LED 12 is outcoupled from the envelope 20 along the entire area of the envelope 20. Alternatively, light from the LED 12 is outcoupled from the envelope 20 at least along the total height of the envelope 20, where height is measured perpendicular to a surface or board where a socket connector of the lighting device 10 interfaces with the envelope 20.

The envelope 20 may be configured to emit light such that at least 50% of the area of the envelope 20 emits light with a luminance that differs less than a factor of five from the average luminance of the envelope 20. The envelope 20 may be configured e.g. by selecting a material, shape, and thickness that achieves this.

Further, the envelope 20 may be configured to emit light such that at least 50%, 70%, or 80% of the area of the envelope 20 emits light with a luminance that differs less than a factor of two or five or ten from the average luminance of the envelope.

For example, the envelope 20 may be made of polymethyl methacrylate (PMMA), glass, or polycarbonate. The envelope 20 may further be made of silicone or polyurethane.

It is noted that close to the LED 12, the envelope 20 may emit light with a luminance that is significantly brighter than other portions of the envelope 20. Accordingly, the envelope 20 may be configured to, when acting as a light-guide for the LED 12, emit light such that at least 50% of the area of the envelope not including a portion closest to the LED, such as within 1 cm, emits light with a luminance that differs less than a factor of five from the average luminance of the envelope 20.

The thickness of the envelope 20 may be between 0.2 mm to 4 mm, preferably between 0.5 mm to 2 mm, such as 1 mm. The envelope 20 is preferably thicker than the LED 12 such that the envelope 20 efficiently catches the emitted light when acting as a light guide.

The LED 12 may be integrated with or arranged in connection with the surface where a socket connector of the lighting device 10 interfaces with the envelope 20.

The LED 12 may be arranged as a circle (or any other shape, depending on the lighting device 10) along the entire edge of the envelope 20, e.g. the interface between the socket connector of the lighting device 10 and the envelope 20. Alternatively, the LED 12 may be arranged at two to eight discrete points at the edge of the envelope 20. The two to eight discrete points may be equally spaced apart along the edge of the envelope 20.

The LED 12 is configured to emit light with a minimum luminance threshold when the light emitting element 11 emits light above a predetermined threshold of luminance.

The LED 12 will thereby affect the envelope 20 to glow (more) when the light emitting element 11 emits light above a predetermined threshold of luminance. This reduces a brightness contrast between the light emitting element 11 and its surroundings and increases the effective area of the light emitted by the lighting device 10. The LED 12 is thereby enabled to reduce glare when the light emitting element 11 emits enough luminance to be perceived as glary.

The minimum luminance threshold may be proportional to an amount of flux emitted by the light emitting element 11. Accordingly, as the light emitting element 11 gets brighter, the envelope 20 acting as a light guide for the LED 12 will also get brighter, thereby ensuring a relatively constant brightness contrast between the light emitting element 11 and its surroundings.

For example, when the light emitting element 11 emits light in the range of 500-1000 lm, the LED 12 emits light in the range of 100-1000 lm. When the light emitting element 11 emits light in the range of 1000-2000 lm, the LED 12 emits light in the range of 500-2000 lm.

In general, the light emitted from the LED 12 may be around two to twenty times less bright than the light emitted by the light emitting element 11. This would mean that, if the surface area of the envelope 20 is ten to twenty times larger than the light emitting element 11, the light emitted by the light emitting element 11 is around the same order of magnitude of flux as the light emitted by the LED 12. This results in a luminance of the light emitted from the envelope 20 as a result of it acting as a light guide for the LED 12 that is around an order of magnitude less than the light emitted by the light emitting element 11.

The luminance of the LED 12, when measured as the output of the envelope 20 when acting as a light guide, may be configured to always be equal to or lower than that of the light emitting element 11. This enables the light emitting element 11 to remain visible, maintaining a visual appearance consistency of the lighting device 10, which may otherwise be jarring to users.

If the LED 12 emits light with a higher flux than the light emitting element 11 at a ratio that equals the ratio (when also taking the angular emission profile into account as luminous flux is measured in lumen and candela is lumen per steradian) of the size difference between the light emitting element 11 and the envelope 20, the light emitted by the light emitting element 11 and the envelope 20 will have a similar level of luminance.

Since the LED 12 emits light, this increases the total flux emitted by the lighting device 10 when compared to a conventional lighting device with only a light emitting element 11. Accordingly, the mere presence of the LED 12 allows spreading out the light emitting area and sources while maintaining the total amount of flux, thereby reducing not only the glare from the light emitting element 11 but also the absolute glare of the lighting device 10.

The light emitting element 11 and the LED 12 may emit white and/or colored light. The light emitting element 11 and the LED 12 may emit the same or a different color, hue, (correlated) color temperature, brightness, or intensity.

In one embodiment, the light emitting element 11 emits white light and the LED 12 emits colored light, e.g. being a set of RGB LEDs. This has an effect of shifting a color point of the emitted light to have a lower color saturation in an energy-efficient manner that is simple to control. This may further result in a specific aesthetic appearance of the lighting device 10 that e.g. enhances the ambience created by the lighting device 10, which would not be possible without the specific features of the lighting device 10.

In an embodiment the lighting device comprises a controller that is arranged to control the light emitting element 11 and the LED 12 independently.

The light emitting element 11 and the LED 12 may be separately controllable. Controlling each of the light emitting element 11 and the LED 12 may comprise adjusting a color, brightness, or intensity of the light emitting element 11 and/or the LED 12. This may comprise sending control signal(s) from a lighting control system to the light emitting element 11 and the LED 12, e.g. wired or wirelessly over Wi-Fi or Bluetooth®.

In an embodiment, the controller is arranged to maintain the total color point output of the lighting device when the outer lightguide is turned on. This is achieved by increasing the brightness of the envelope when the filament is switched on or when the brightness of the filament is above a certain threshold. This way, the brightness contrast is greatly reduced and the lighting device can be operated with higher flux output without being glary.

By increasing the brightness of the envelope the total color point of the lamp may go off-target. The controller may by tuning the color point of the LED filament or of the lightguide bring the color point back to its target value.

By calibrating the contribution of the light emitting element (the LED filament) and the light of the LED (the envelope) separately the wanted total flux and color output can be easily tuned. This correction is dependent on the relative flux of the lightguide filament lamp with respect to the flux coming from the outer bulb.

As a result, the lamp will give a nice decorative effect without any possible color appearance of the surrounding area. This is especially important when other “white” lamps are emitting in the same area.

In a further embodiment the controller is arranged to couple the light setting of the LED depending on the light setting of the light emitting element. This mode of the controller may be of particular interest for non-connected systems. Controlling two light sourced independently is easy in the case of connected systems, where an extensive user interface can be used to control both light sources. However, for non-connected systems, it is not simple to address both light sources with a single control (usually a dimmer or a wall switch). For the lighting device of the present invention a smart way to control it is proposed. The light setting of the second light source is depending on the setting of the first light source: e.g. depending on the required flux output, only one or both light sources are switched on.

It is proposed that the light emerging from the two sources are coupled and controlled by the existing infrastructure in consumer homes, i.e. a normal dimmer or a normal on/off switch. The dimmer or on/off signals will be translated in the lighting device to different light settings for the two light sources. Depending on the dimmer position, one or both light sources are turned on.

As an example when using a dimmer, at low dimmer position it sets the flux for the LED filament (the light emitting element) only. At certain flux level: the LED filament does not increase flux anymore, but the LED is switched on and increases flux with increasing dimmer position. Alternatively, the dimmer position can control three stages:
the light emitting element flux changes (increases) and the LED is in the off state. When the dimmer is in low position, e.g. below 25%, only a low light level is required and only the LED filament will respond to the dimmer signal and radiate flux in relation to the dimmer position.
the light emitting element flux changes (increases) and the LED flux also changes (increases). When the dimmer is in medium position (e.g. between 25-75%), the light guide will also start to glow and both the light guide source and the LED filament will increase flux corresponding to the dimmer position.
the light emitting element flux is constant (above a certain value) and the LED flux changes (up to max level). When the dimmer is in high position (e.g. above 75%), only the light guide will respond to increasing %, the LED filament will remain at the same value as at 75% setting).

By combining the layer 22 of phosphor with the LED 12, both reducing the glare of the light emitting element 11, the lighting device 10 may be made more energy efficient and the manufacturer has more control over aesthetic considerations of the lighting device 10, such as patterns and color options or combinations.

The person skilled in the art realizes that the present invention by no means is limited to the preferred embodiments described above. On the contrary, many modifications and variations are possible within the scope of the appended claims.

1. A lighting device comprising:
a light emitting element, and
a translucent envelope enclosing the light emitting element and having a surface area at least three times bigger than the light emitting area of the light emitting element,
an LED arranged in connection with the envelope, such that the envelope acts as a light guide for the LED,
wherein the envelope is coated with a layer of phosphor with a thickness of 0.05-1.0 mm and the layer of phosphor is configured to block less than 30% of the visible light emitted by the light emitting element, and
wherein the LED is configured to emit light with a minimum luminance threshold when the light emitting element emits light above a predetermined threshold of luminance, affecting the envelope to glow and reduces a brightness contrast between the light emitting element and the LED, thereby reducing glare.

2. The device of claim 1, wherein the phosphor is organic phosphor.

3. The device of claim 1, wherein the thickness of the layer of phosphor differs in different portions of the envelope.

4. The device of claim 1, wherein the layer of phosphor comprises scattering particles different from phosphor.

5. The device of claim 1, wherein the envelope is only coated with said layer of phosphor.

6. The device of claim 1, wherein the light emitting element comprises a separately controllable UV light source and wherein the layer of phosphor is configured to absorb UV light and re-emit it as visible light.

7. The device of claim 1, wherein the light emitting element is an LED filament.

8. The device of claim 1, wherein the layer of phosphor is at least one of patterned or comprises grinded particles of a polymer incorporating the phosphor.

9. The device of claim 1, wherein the light emitting element comprises a phosphor converting LED with a centroid wavelength of 450 nm and a yellow phosphor to generate white light, and the LED comprises a blue emitting LED with a centroid wavelength of 430 nm or the envelope is provided with a blue light emitting phosphor,
wherein the light emitted by the lighting device will have a nice white appearance in the far field.

10. The device of claim 1, wherein the lighting device comprises a controller that is arranged to control the light emitting element 11 and the LED 12 independently.

11. The device of claim 10, wherein the controller is a dimmer having a dimmer position arranged to control three stages:
dimmer is in a low position: the light emitting element flux changes (increases) and the LED is in the off-state
dimmer is in medium position: the light emitting element flux changes (increases) and the LED flux also changes (increases)
dimmer is in high position the light emitting element flux is constant (above a certain value) and the LED flux changes (up to max level).

12. The device of claim 1, wherein the envelope is configured to, when acting as a light-guide for the LED, emit light such that at least 50% of the area of the envelope emits light with a luminance that differs less than a factor of five from an average luminance of the envelope.

13. The device of claim 1, wherein the LED is configured to emit light with a minimum luminance threshold when the light emitting element emits light above a predetermined threshold of luminance.

14. The device of claim 13, wherein the minimum brightness threshold is proportional to an amount of flux emitted by the light emitting element.

15. The device of claim 1, wherein the envelope is made of PMMA, glass, or polycarbonate.
